(19) United States
(12) Patent Application Publication
(10) Pub. No.: US 2012/0060547 A1
(43) Pub. Date: Mar. 15, 2012

(54) MOTOR FOR COMPRESSOR, COMPRESSOR AND REFRIGERATION CYCLE APPARATUS

(75) Inventors: Yoshikazu Fujisue, Chiyoda-ku (JP); Koji Yabe, Chiyoda-ku (JP); Hayato Yoshino, Chiyoda-ku (JP)

(73) Assignee: Mitsubishi Electric Corporation, Chiyoda-ku (JP)

(21) Appl. No.: 13/228,000

(22) Filed: Sep. 8, 2011

(30) Foreign Application Priority Data
Sep. 10, 2010 (JP) 2010-202558

(51) Int. Cl. F25B 1/00; F04B 35/04; H02K 21/12

(52) U.S. Cl. 62/498; 310/156.01; 417/410.1

(57) ABSTRACT

A motor for a compressor comprises: a stator including a plurality of slots each having a slot opening, teeth formed between neighboring slots; and a rotor arranged at an inner side of the stator, a number of permanent magnet holes, the number of which is same as a number of magnetic poles, and permanent magnets. The rotor includes at least a first pair of slits, provided at an outer peripheral core part of the permanent magnet inserting hole, extending orthogonally to the inserting hole, arranged symmetrically with respect to a magnetic pole center, and a distance between the first pair of slits is smaller than a width of the teeth; and a second pair of slits, arranged at an outer inter-pole side of the first pair of slits, provided at a position where the tooth and the magnetic pole center of the rotor match, and facing the slot openings.

### CROSS-REFERENCE TO RELATED APPLICATIONS

This application is based on and claims the benefit of priority from Japanese Patent Application No. 2010-202558, filed in Japan on Sep. 10, 2010, the content of which is incorporated herein by reference in its entirety.

### TECHNICAL FIELD

The present invention relates to a highly efficient motor for a compressor which suppresses cogging torque that may cause vibration or noise, a compressor using the motor for compressor, and a refrigeration cycle apparatus using the compressor.

### BACKGROUND ART

Generally, a slit is formed in order to suppress transverse flux and solve magnetic flux saturation caused by armature reaction and trace delay caused by reluctance torque on a permanent magnet synchronous motor, in particular, a magnet embedded type in which a permanent magnet is inserted into a magnet inserting hole. A slit is formed between the magnet inserting hole and an outer peripheral surface of a rotor core.

A permanent magnet type synchronous rotating electrical machine has been proposed, in which the position of the slit with respect to the stator teeth position is devised so as to decrease the transverse flux. In the permanent magnet type synchronous rotating electrical machine including a stator core and a rotor core, the magnet inserting hole is formed on the rotor core, and a permanent magnet is inserted into the magnet inserting hole, in the rotor core, two or more slits are formed from the surface at the outer peripheral side of the rotor core of the magnet inserting hole towards the outer peripheral direction of the rotor core, and further, the slit are placed at the position facing the end part of the stator teeth in the peripheral direction (refer to Patent Literature 1, for instance).

### CITATION LIST

Patent Literature

Patent Literature 1: JP2001-25194A

### SUMMARY OF INVENTION

### Technical Problems

However, in the permanent magnet type synchronous rotating electrical machine described in the Patent Literature 1, two or more slits are formed from the surface at the outer peripheral side of the rotor core of the magnet inserting hole towards the outer peripheral direction of the rotor core, and further, the slits are arranged at the position facing the end part of the stator teeth in the peripheral direction, thereby solving magnetic flux saturation caused by armature reaction and trace delay caused by reluctance torque. The patent literature tries to increase the torque by the above configuration, but does not try to decrease the vibration or noise caused by the cogging torque.

The cogging torque is a force which is inevitably generated at a salient-pole permanent magnet motor (the same as the permanent magnet type synchronous rotating electrical machine), which is a torque pulsation generated by the change of the magnetic attractive force with respect to the position of the rotor (the rotation angle) which is worked between the teeth (the teeth part) of the stator and the permanent magnet provided at the rotor at the time of discontinuity. Namely, at the position where the magnetic resistance is minimized between the stator and the rotor, it is the most stable magnetically, and the rotor tends to halt there. Further, in order to rotate the rotor from that position, it is necessary to have a torque sufficient to overcome the magnetic attractive force. However, once the rotation is started at a certain speed, the torque becomes a vibrational torque in which positive/negative torques are switched, and an average value of the cogging torque becomes zero.

The generation of the cogging torque causes the change of the speed, the cogging torque transmits along the shaft of the rotor to cause vibration or noise, and as well works like the static torque to increase the starting torque of the motor (the permanent magnet motor). At the same time, the magnetic flux is changed due to the rotation of the rotor; therefore, when a hysteresis loss or an eddy-current loss exists, it works like solid friction and viscous friction. Therefore, it is necessary to decrease the cogging torque. The cogging torque is generated by the change of the magnetic resistance between the stator and the rotor according to the rotation angle, and results from the maxwell stresses that are proportional to the square of the magnetic flux density. The change of the magnetic resistance largely depends on the slot spatial harmonic of the stator or the harmonic component of the magnetic flux of the permanent magnet provided at the rotor. Therefore, in order to decrease the cogging torque, it is desired to smooth the magnetic flux density distribution of a gap part in the peripheral direction and decrease the harmonic component.

The present invention aims to solve the above problems, which provides a motor for a compressor which can effectively utilize the magnetic flux of the permanent magnet and further can decrease the cogging torque, a compressor using the motor, and a refrigeration cycle apparatus using the compressor.

### Solution to Problem

According to the present invention, a motor for a compressor includes: a stator formed by laminating a predetermined number of electromagnetic plates, each of which has been punched out into a predetermined shape, the stator having a plurality of slots arranged in a peripheral direction with an approximate equal intervals and each having a slot opening that opens at an inner periphery, teeth formed between neighboring slots, and coils wound around the teeth; and a rotor arranged at an inner side of the stator with an air gap, and formed by laminating a predetermined number of electromagnetic plates, each of which has been punched out into a predetermined shape, the rotor having permanent magnet inserting holes formed along an outer peripheral edge, as many as a number of magnetic poles, and permanent magnets to be inserted into the permanent magnet inserting holes, the rotor includes at least a first pair of slits provided at an outer peripheral core part of each of the permanent magnet inserting holes, extending orthogonally to the each of the permanent magnet inserting holes, and arranged symmetrically with respect to a magnetic pole center, a distance between the first pair of slits being smaller than a width of each of the teeth; and a second pair of slits provided at the outer peripheral core part of the each of the permanent magnet inserting holes, each of the second pair of slits being arranged at an outside of each of the first pair of slits where it is farther from the magnetic pole center than the each of the first pair of slits, and facing the slot opening when one of the teeth and the magnetic pole center are aligned.

### Advantageous Effects of Invention

In the motor for compressor according to the present invention, the rotor includes, in the outer peripheral core part of the permanent magnet inserting hole, at least a pair of first slits, extending orthogonally to the permanent magnet inserting hole, arranged symmetrically with respect to a magnetic pole center, and arranged with a distance between the pair of first slits being shorter than the width of the teeth; and a pair of second slits arranged at the outer inter-pole side of the pair of first slits, and provided facing slot openings at the position where a tooth and the magnetic pole center of the rotor match. Thus, the magnetic flux of the permanent magnet can be effectively used, and further, the cogging torque can be reduced.

### BRIEF EXPLANATION OF THE DRAWINGS

The present invention will become fully understood from the detailed description given hereinafter in conjunction with the accompanying drawings, in which:

FIG. 1 shows the first embodiment, which is a vertical cross sectional view of a two-cylinder rotary compressor 1;

FIG. 2 shows the first embodiment, which is a cross sectional view of a motor 100;

FIG. 3 shows the first embodiment, which is a cross sectional view of a stator 3;

FIG. 4 shows the first embodiment, which is a cross sectional view of a rotor 4;

FIG. 5 shows the first embodiment, which is a cross sectional view of a rotor core 40;

FIG. 6 is an enlarged view of A part in FIG. 2;

FIG. 7 shows the first embodiment, which is a cross sectional view of a motor 300 of a deformed example;

FIG. 8 shows the first embodiment, which is a cross sectional view of a rotor 4-1 of the deformed example;

FIG. 9 shows the first embodiment, which is a cross sectional view of a rotor core 40-1 of the deformed example;

FIG. 10 is an enlarged view of B part in FIG. 7;

FIG. 11 is shown for comparison, which is a partial enlarged view of a motor 400 of a comparison example 1 (without slits);

FIG. 12 is shown for comparison, which is a partial enlarged view of a motor 500 of a comparison example 2;

FIG. 13 shows a waveform of a cogging torque of the motor 400 of the comparison example 1;

FIG. 14 shows a waveform of a cogging torque of the motor 500 of the comparison example 2;

FIG. 15 shows the first embodiment, which is a diagram showing a waveform of the cogging torque of the motor 100;

FIG. 16 shows the first embodiment, which is a diagram showing a waveform of the cogging torque of the motor 300 of the deformed example;

FIG. 17 shows the first embodiment, which compares cogging torques of the comparison example 1, the comparison example 2, the motor 100, and the motor 300;

FIG. 18 shows the first embodiment, which compares torques of the comparison example 1, the comparison example 2, the motor 100, and the motor 300;

FIG. 19 is a reference drawing showing a transverse flux;

FIG. 20 is a reference drawing showing that a slit is provided facing a slot opening or an end part of a tooth of the stator, thereby suppressing transverse flux; and

FIG. 21 shows the first embodiment, which is a configuration diagram of a refrigeration cycle apparatus using a two-cylinder rotary compressor 1.

### DESCRIPTION OF EMBODIMENTS

In describing preferred embodiments illustrated in the drawings, specific terminology is employed for the sake of clarity. However, the disclosure of the present invention is not intended to be limited to the specific terminology so selected, and it is to be understood that each specific element includes all technical equivalents that operate in a similar manner and achieve a similar result.

### Embodiment 1

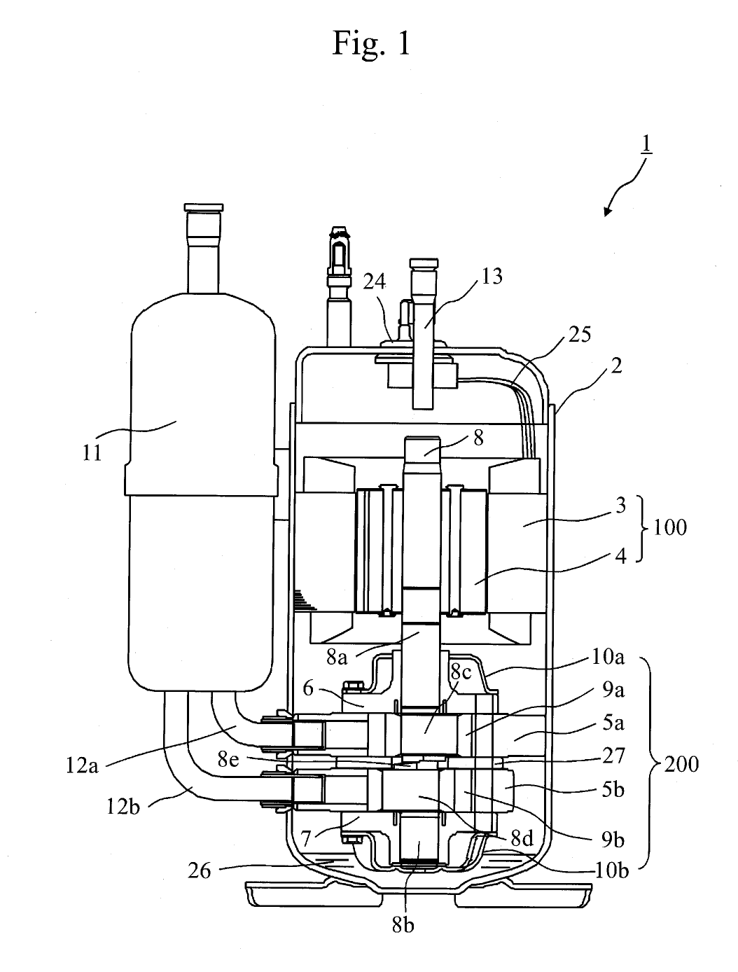

FIG. 1 shows the first embodiment, which is a vertical cross sectional view of a two-cylinder rotary compressor 1. With reference to FIG. 1, a configuration of the two-cylinder rotary compressor 1 (an example of a hermetic compressor) will be explained. The two-cylinder rotary compressor 1 contains, in a hermetic container 2 which is high-pressure ambience, a motor 100 (a motor for a compressor) composed of a stator 3 and a rotor 4, and a compressor mechanism part 200 driven by the motor 100. The motor 100 is a brushless DC motor, in which a permanent magnet is used for the rotor 4.

Here, the two-cylinder rotary compressor 1 will be explained as an example of a hermetic compressor; however, other compressors such as a scroll compressor, a one-cylinder rotary compressor, a multi-stage rotary compressor, a swing rotary compressor, a vane compressor, a reciprocating compressor, etc. can be also used.

The rotating force of the motor 100 is transmitted to the compressor mechanism part 200 through a main shaft 8a of a rotating shaft 8.

The rotating shaft 8 includes, the main shaft 8a fixed to the rotor 4 of the motor 100, an auxiliary shaft 8b provided at the opposite side of the main shaft 8a, a main shaft side eccentric part 8c and an auxiliary shaft side eccentric part 8d formed between the main shaft 8a and the auxiliary shaft 8b with a predetermined phase difference (for instance, 180 degrees), and an intermediate shaft 8e provided between the main shaft side eccentric part 8c and the auxiliary shaft side eccentric part 8d.

A main bearing 6 is fitted to the main shaft 8a of the rotating shaft 8 with a clearance for sliding, thereby supporting the main shaft 8a so as to freely rotate.

Further, a auxiliary bearing 7 is fitted to the auxiliary shaft 8b of the rotating shaft 8 with a clearance for sliding, thereby supporting the auxiliary shaft 8b so as to freely rotate.

The compressor mechanism part 200 includes a first cylinder 5a of the main shaft 8a side and a second cylinder 5b of the auxiliary shaft 8b side.

The first cylinder 5a includes a cylindrical internal space, the internal space is provided with a first piston 9a (a rolling piston) fitted to the main shaft side eccentric part 8c of the rotating shaft 8 so as to freely rotate. Further, a first vane (not shown) is provided, which reciprocates according to the rotation of the main shaft side eccentric part 8c.

The first vane is contained within a vane groove of the first cylinder 5a, and is always pressed to a first piston 9a by a vane spring (not shown) provided at a back pressure chamber. The two-cylinder rotary compressor 1, since the inside of the hermetic container 2 is high pressure, upon starting driving, a force caused by a pressure difference between the high pressure inside the hermetic container 2 and the pressure in the cylinder chamber is worked on the back surface of the vane (the back pressure chamber side), the vane spring is used so as to press the first vane to the first piston 9a mainly at the time of starting the two-cylinder rotary compressor 1 (the status where there is no pressure difference between the inside of the hermetic container 2 and the pressure in the cylinder chamber). The shape of the first vane is almost flat (the thickness in the peripheral direction is smaller than the length in the diameter direction and the axial direction) cuboid. Here, a second vane, which will be discussed later, has the same configuration.

The first cylinder 5a is penetrated by the suction port (not shown), through which suction gas from a refrigeration cycle passes, from an outer peripheral side of the first cylinder 5a to a cylinder chamber. The first cylinder 5a is provided with a discharge port (not shown) having a notch around the edge part (an end face of the motor 100 side) of a circle forming the cylinder chamber which is an approximately circular space.

Both end faces of the first piston 9a fitted to the main shaft side eccentric part 8c of the rotating shaft 8 so as to freely rotate and the internal space of the first cylinder 5a containing the first vane in the axial direction are sealed by the main bearing 6 and a partitioning plate 27, thereby forming the compressor chamber.

The first cylinder 5a is fixed to the inner periphery of the hermetic container 2.

The second cylinder 5b also includes a cylindrical internal space, and the internal space is provided with a second piston 9b (a rolling piston) fitted to the auxiliary shaft side eccentric part 8d of the rotating shaft 8 so as to freely rotate. Further, a second vane (not shown) is provided, which reciprocates according to the rotation of the auxiliary shaft side eccentric part 8d. The first piston 9a and the second piston 9b are simply defined as “a piston”.

The second cylinder 5b is also penetrated by the suction port (not shown), through which the suction gas from the refrigeration cycle passes, from the outer peripheral side of the second cylinder 5b to the cylinder chamber. The second cylinder 5b is provided with a discharge port (not shown) having a notch around the edge part (an end face opposite to the motor 100 side) of a circle forming the cylinder chamber which is an approximately circular space.

Both end faces of the second piston 9b fitted to the auxiliary shaft side eccentric part 8d of the rotating shaft 8 so as to freely rotate and the internal space of the second cylinder 5b containing the second vane in the axial direction are sealed by the auxiliary bearing 7 and the partitioning plate 27, thereby forming the compressor chamber.

In the compressor mechanism part 200, after fastening by bolt the first cylinder 5a and the main bearing 6, and the second cylinder 5b and the auxiliary bearing 7, the partitioning plate 27 is inserted between them; bolt fastening and fixing is done from the outside of the main bearing 6 to the second cylinder 5b, and from the outside of the auxiliary bearing 7 to the first cylinder 5a in the axial direction.

A discharge muffler 10a is attached to the outside (the motor 100 side) of the main bearing 6. High temperature and high pressure discharge gas discharged from a discharge valve (not shown) provided at the main bearing 6 is once inflows to a discharge muffler 10a, and then discharged to the hermetic container 2 through a discharge hole (not shown) of the discharge muffler 10a.

A discharge muffler 10b is attached to the outside (the opposite side of the motor 100) of the auxiliary bearing 7. High temperature and high pressure discharge gas discharged from the discharge valve (not shown) provided at the auxiliary bearing 7 is once inflows to the discharge muffler 10b, and then discharged to the hermetic container 2 through a discharge hole (not shown) of the discharge muffler 10b.

An accumulator 11 is provided next to the hermetic container 2. A suction tube 12a and a suction tube 12b respectively connect the first cylinder 5a, the second cylinder 5b, and the accumulator 11.

The refrigerant gas which is compressed in the first cylinder 5a and the second cylinder 5b is discharged to the hermetic container 2, and is sent to the high-pressure side of the refrigeration cycle of the cooling air-conditioner through a discharge tube 13.

Further, electric power is supplied to the motor 100 from a glass terminal 25 through a lead wire 24.

In the bottom part of the hermetic container 2, lubricant oil 26 (refrigerant oil) for lubricating each sliding part of the compressor mechanism part 200 is reserved.

As for the supply of the lubricant oil to each sliding part of the compressor mechanism part 200, the lubricant oil 26 reserved in the bottom part of the hermetic container 2 is raised along the internal surface of the rotating shaft 8 by the centrifugal force caused by the rotation of the rotating shaft 8, and supplied through an oil supply hole (not shown) provided at the rotating shaft 8. The lubricant oil is supplied to the main shaft 8a, the main bearing 6, the main shaft side eccentric part 8c, the first piston 9a, and sliding parts between the auxiliary shaft side eccentric part 8d and the second piston 9b and between the auxiliary shaft 8b and the auxiliary bearing 7 from the oil supply hole.

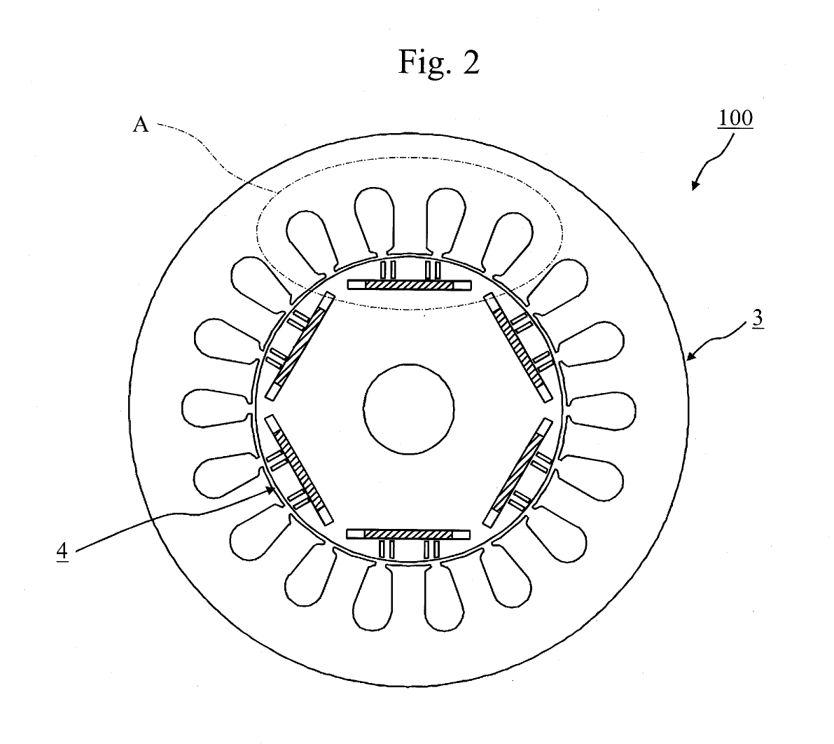

FIG. 2 shows the first embodiment, which is a cross sectional view of the motor 100. As shown in FIG. 2, the motor 100 includes the stator 3 and the rotor 4. The motor 100 is a six-pole brushless DC motor having six permanent magnets (which will be discussed later) in the rotor 4. Hereinafter, the stator 3 and the rotor 4 will be explained in order.

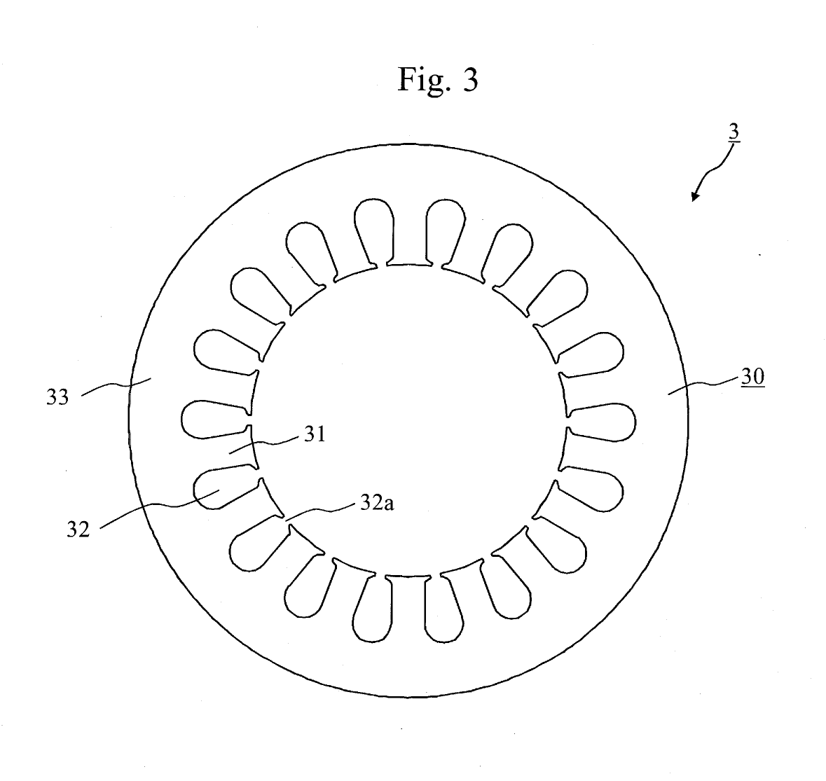

FIG. 3 shows the first embodiment, which is a cross sectional view of the stator 3. The stator 3 shown in FIG. 3 includes a stator core 30 and windings (not shown) provided at the stator core 30 through an insulating member (not shown).

The stator core 30 is formed by laminating a predetermined number of electromagnetic plates (the plate thickness is 0.1 to 1.5 mm) each of which has been punched out into a predetermined shape. Respective electromagnetic plates are combined (fixed) by, for instance, caulking or welding, etc.

The shape of the stator core 30 is an approximate ring shape. A ring-shaped coreback 33 is formed around an outer periphery of the stator core 30. Teeth 31 are formed at the inner side of the coreback 33, extending radially in a radial direction. Here, eighteen teeth 31 are formed in a peripheral direction with approximate equal intervals. The widths of the teeth in a peripheral direction are approximately the same in the radial direction. Both tips of the teeth 31 in the peripheral direction are projected in the peripheral direction.

A slot 32 (space) is formed between two neighboring teeth 31. The slot 32 has an opening at the inner side (the rotor 4 side), and the opening is referred to as a slot opening 32a (a slot opening part). Since the widths of the teeth in a peripheral direction are approximately the same in a radial direction, the width of the slot 32 in the peripheral direction is small at the inner side (the rotor 4 side), increasing towards the outside (the coreback 33 side). Winding (not shown) is inserted to the slot 32 from the slot opening 32a.

Although it is not shown in the figure, when the motor 100 is used for a hermetic compressor such as the two-cylinder rotary compressor 1, in order to secure a passage of refrigerant or refrigerant oil, the outer periphery of the stator core 30 is provided with a notched part.

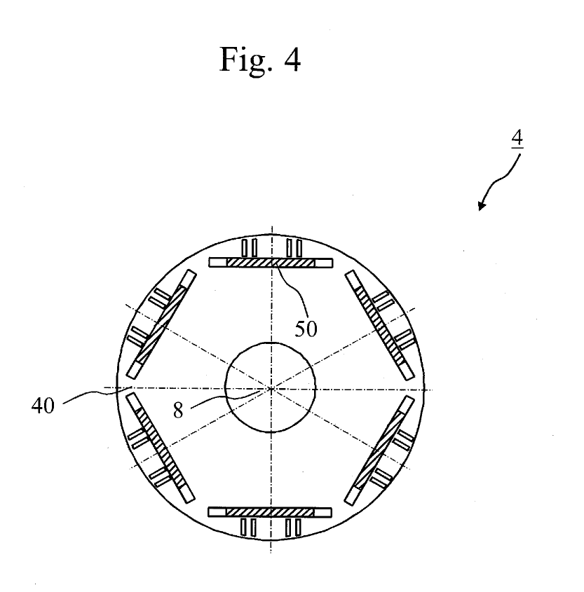

FIG. 4 shows the first embodiment, which is a cross sectional view of the rotor 4. As shown in FIG. 4, the rotor 4 includes a rotor core 40, a permanent magnet 50 to be inserted to a magnet inserting hole (which will be discussed later) of the rotor core 40, and the rotating shaft 8 fixed to the center part of the rotor core 40. The rotor 4 of FIG. 4 is a six-pole rotor having six permanent magnets 50. The shape of the permanent magnet 50 is flat plate-like. Rare earths having main components of, for instance, neodymium, iron, boron, etc. are used for the permanent magnet 50.

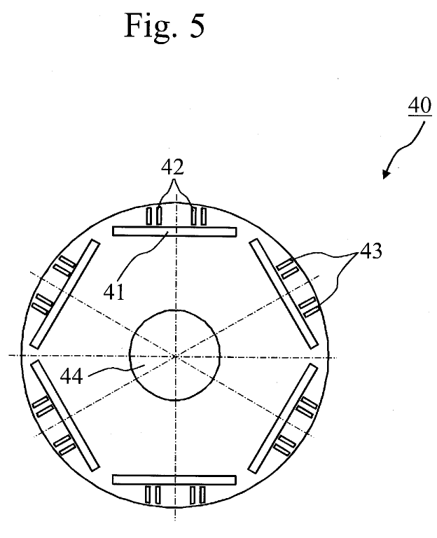

FIG. 5 shows the first embodiment, which is a cross sectional view of the rotor core 40. The rotor core 40 is formed by laminating a predetermined number of electromagnetic plates (the plate thickness is 0.1 to 1.5 mm) each of which has been punched out into a predetermined shape. Respective electromagnetic plates are combined (fixed) by, for instance, caulking, etc.

As shown in FIG. 5, in the rotor core 40, a number (six) of magnet inserting holes 41, the number of which is the same as the permanent magnets 50, having a rectangular cross section are formed along the outer peripheral edge. Further, though a detail will be discussed later, at least a pair of first slits 42 and a pair of second slits 43 are formed at the outside core part of the magnet inserting hole 41. The pair of first slits 42 and the pair of the second slits 43 are arranged symmetrically with respect to a magnetic pole center. The pair of first slits 42 is the closest to the magnetic pole center, the pair of the second slits 43 is the second closest to the magnetic pole center. Although slits are provided other than the pair of first slits 42 and the pair of the second slits 43, they do not relate to the features of the present embodiment, and thus illustration is omitted. A shaft hole 44 to which the rotating shaft 8 is fixed is provided at the center part of the rotor core 40.

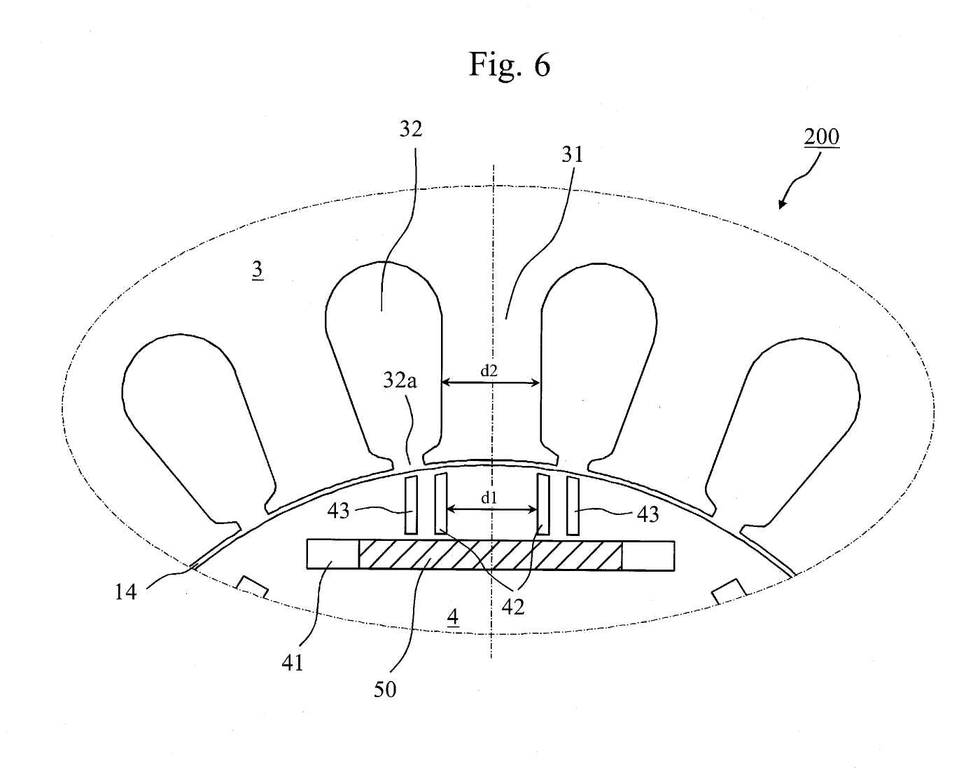

FIG. 6 is an enlarged view of a part A of FIG. 2. With reference to FIG. 6, the first slit 42 and the second slit 43 will be explained in detail. The first slit 42 and the second slit 43 are formed on the outside core part of the magnet inserting hole 41 orthogonally to the magnet inserting hole 41. The core parts between the first slits 42, the second slits 43, and the magnet inserting hole 41 are thin; the width is around the thickness of the electromagnetic plate (0.1 to 1.5 mm)

At the position where the tooth 31 of the stator core 30 and the magnetic pole center of the rotor 4 match, the second slits 43 are provided so as to face the slot openings 32a of the stator core 30. The advantageous effect of providing the second slits 43 facing the slot openings 32a of the stator core 30 will be discussed later. The width of the second slits 43 in a peripheral direction is, for instance, around 1 mm when the outer diameter of the rotor 4 is around 89 mm.

The first slits 42 are formed closer to the magnetic pole center than the second slits 43. The following shows the definition of d1 and d2:

(1) d1: the distance between the pair of first slits 42; and
(2) d2: the width of the teeth 31 of the stator core 30 in a peripheral direction
The first slits 42 are arranged so that d1<d2. The advantageous effect of arranging the first slits 42 so that d1<d2 will be discussed later. The width of the first slits 42 in a peripheral direction is, for instance, around 1 mm when the outer diameter of the rotor 4 is around 89 mm

An air gap 14 (void) being around 0.3 to 1.5 mm is provided between the rotor 4 and the stator 3.

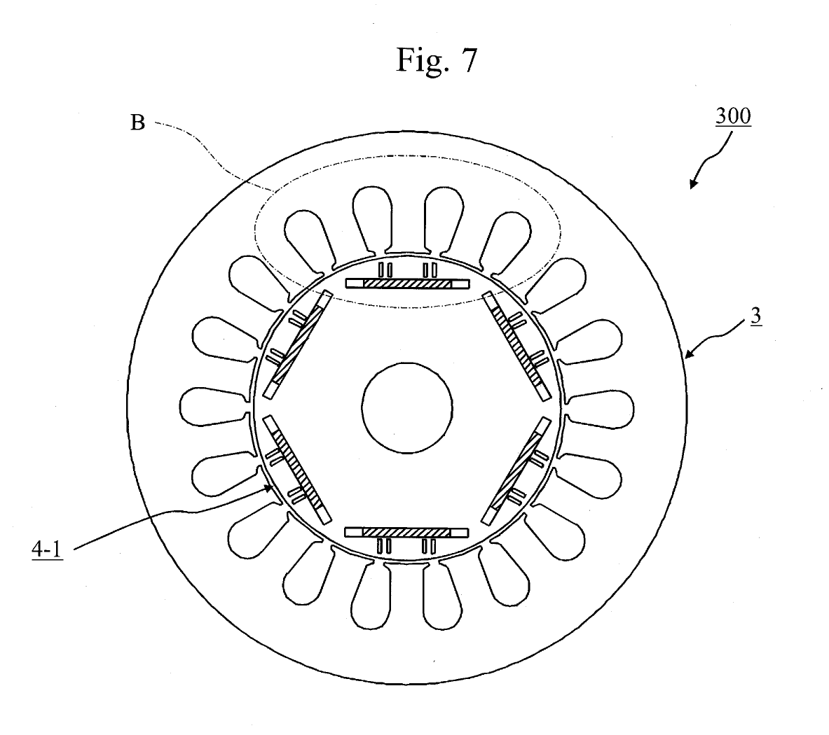

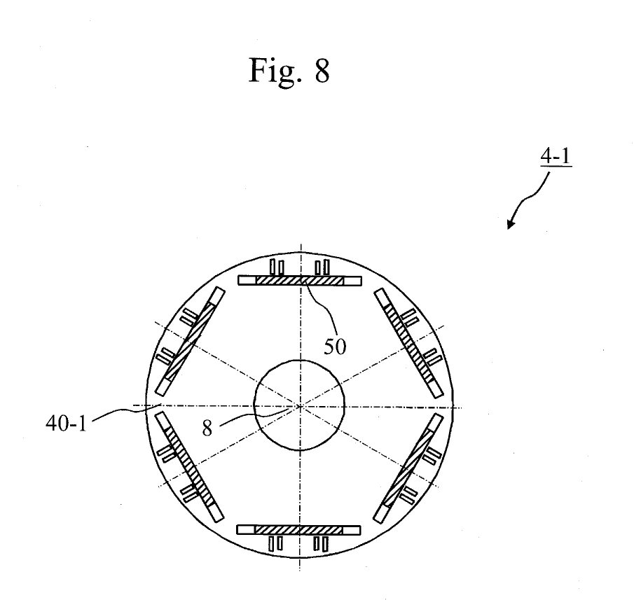

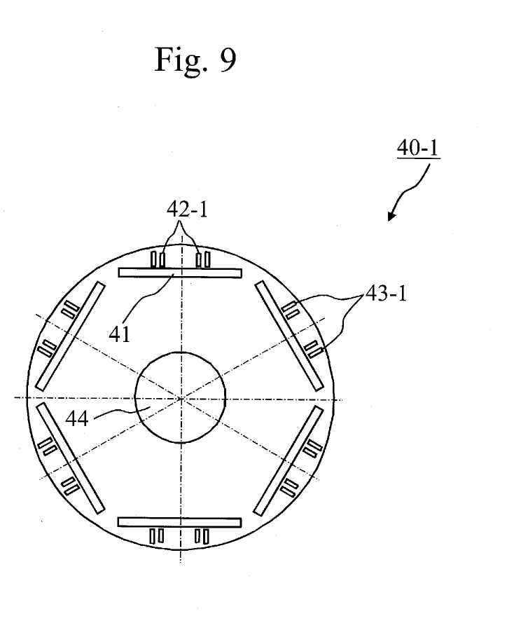

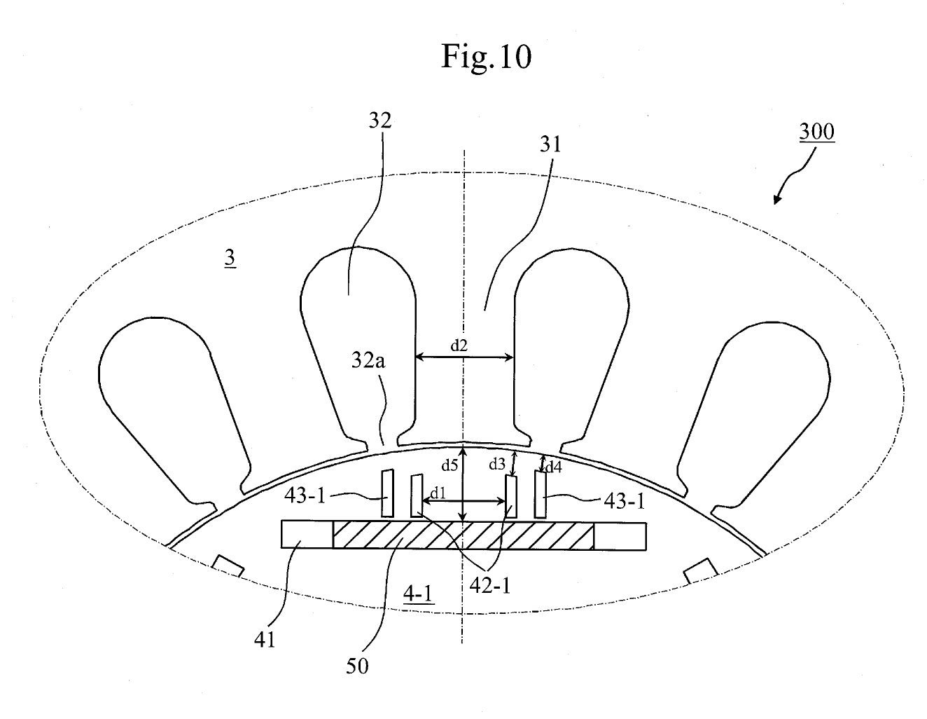

FIGS. 7 to 10 show the first embodiment: FIG. 7 is a cross sectional view of a motor 300 of the deformed example; FIG. 8 is a cross sectional view of a rotor 4-1 of the deformed example; FIG. 9 is a cross sectional view of a rotor core 40-1 of the deformed example; and FIG. 10 is an enlarged view of a part B of FIG. 7.

With reference to FIGS. 7 to 10, the motor 300 of the deformed example will be explained. As shown in FIG. 7, the motor 300 of the deformed example includes the stator 3 and the rotor 4-1. The motor 300 is different from the motor 100 of FIG. 2 in the rotor 4-1. Therefore, the rotor 4-1 will be explained in detail.

As shown in FIG. 8, the rotor 4-1 includes a rotor core 40-1, the permanent magnet 50 to be inserted to a magnet inserting hole (discussed later) of the rotor core 40-1, and the rotating shaft 8 fixed to the center part of the rotor core 40-1. The rotor 4-1 is also a six-pole rotor having six permanent magnets 50. The shape of the permanent magnet 50 is flat plate-like. Rare earths having main components of; for instance, neodymium, iron, boron, etc. are used for the permanent magnet 50.

The rotor core 40-1 is formed by laminating a predetermined number of electromagnetic plates (the plate thickness is 0.1 to 1.5 mm) each of which has been punched out into a predetermined shape. Respective electromagnetic plates are combined (fixed) by, for instance, caulking, etc.

As shown in FIG. 9, in the rotor core 40-1, a number (six) of magnet inserting holes 41, the number of which is the same as the permanent magnets 50, having a rectangular cross section are formed along the outer peripheral edge. Further, though a detail will be discussed later, at least a pair of first slits 42-1 and a pair of second slits 43-1 are formed at the outside core part of the magnet inserting hole 41. The pair of first slits 42-1 and the pair of the second slits 43-1 are arranged symmetrically with respect to the magnetic pole center. The pair of first slits 42-1 is the closest to the magnetic pole center, the pair of the second slits 43-1 is the second closest to the magnetic pole center. Although slits are provided other than the pair of first slits 42-1 and the pair of the second slits 43-1, they do not relate to the features of the present embodiment, and thus illustration is omitted. The shaft hole 44 to which the rotating shaft 8 is fixed is provided at the center part of the rotor core 40-1.

With reference to FIG. 10, the first slits 42-1 and the second slits 43-1 will be explained in detail. The first slits 42-1 and the second slits 43-1 are formed on the outside core part of the magnet inserting hole 41 orthogonally to the magnet inserting hole 41. The core parts between the first slits 42-1, the second slits 43-1, and the magnet inserting hole 41 are thin, the width of which is around the thickness of the electromagnetic plate (0.1 to 1.5 mm).

At the position where the tooth 31 of the stator core 30 match the magnetic pole center of the rotor 4, the second slits 43-1 are formed so as to face the slot openings 32a of the stator core 30, similarly to the second slits 43. The second slits 43-1, being different from the second slits 43, the width of the outer peripheral thin part d4 is made thicker than the width of the outer peripheral thin part of the second slits 43 (around the thickness of the electromagnetic plate). The advantageous effect of forming the second slits 43 thicker will be discussed later.

The width of the second slits 43-1 in a peripheral direction is, for instance, around 1 mm when the outer diameter of the rotor 4 is around 89 mm.

The first slits 42-1 are formed closer to the magnetic pole center than the second slits 43-1. The following shows the definition of d1 to d5:

(1) d1: the distance between the pair of first slits 42-1;
(2) d2: the width of the teeth 31 of the stator core 30 in a peripheral direction;
(3) d3: distance between the first slits 42-1 and the outer perimeter of the rotor 4-1 (the width of the outer peripheral thin part of the first slit 42-1);
(4) d4: the distance between the second slits 43-1 and the outer perimeter of the rotor 4-1 (the width of the outer peripheral thin part of the second slit 43-1); and
(5) d5: the distance between the magnet inserting hole 41 and the outer perimeter of the rotor 4-1 on the magnetic pole center.
The first slits 42-1 are arranged so that d1<d2. The advantageous effect of arranging the first slits 42-1 so that d1<d2 will be also discussed later. The width of the first slits 42 in a peripheral direction is, for instance, around 1 mm when the outer diameter of the rotor 4 is around 89 mm.

The width d3 of the outer peripheral thin part of the first slits 42-1 is thicker than the width of the outer peripheral thin part of the first slits 42 (around the thickness of the electromagnetic plate). d3 is selected so as to satisfy, for instance, the following relationship. Namely,

d5/2>d3>the thickness of each electromagnetic plate and further,

d3>d4.

As for the width d4 of the outer peripheral thin part of the second slits 43-1 which has been discussed above, the width d4 is also selected so as to satisfy the following relationship. Namely,

d5/2>d4>the thickness of each electromagnetic plate

The advantageous effect of forming the second slits 43-1 as above will be also discussed later.

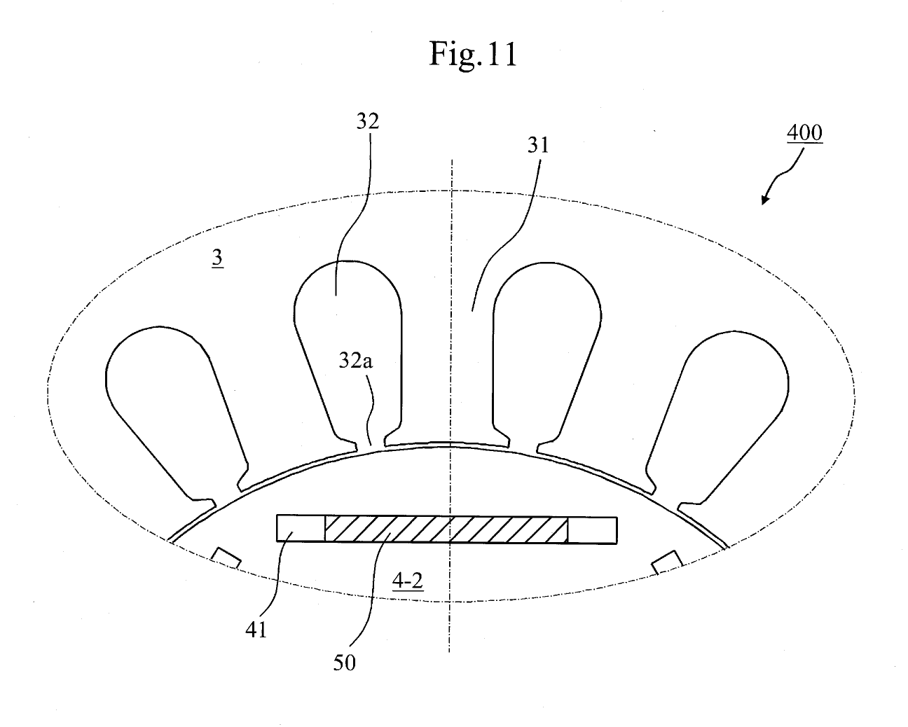

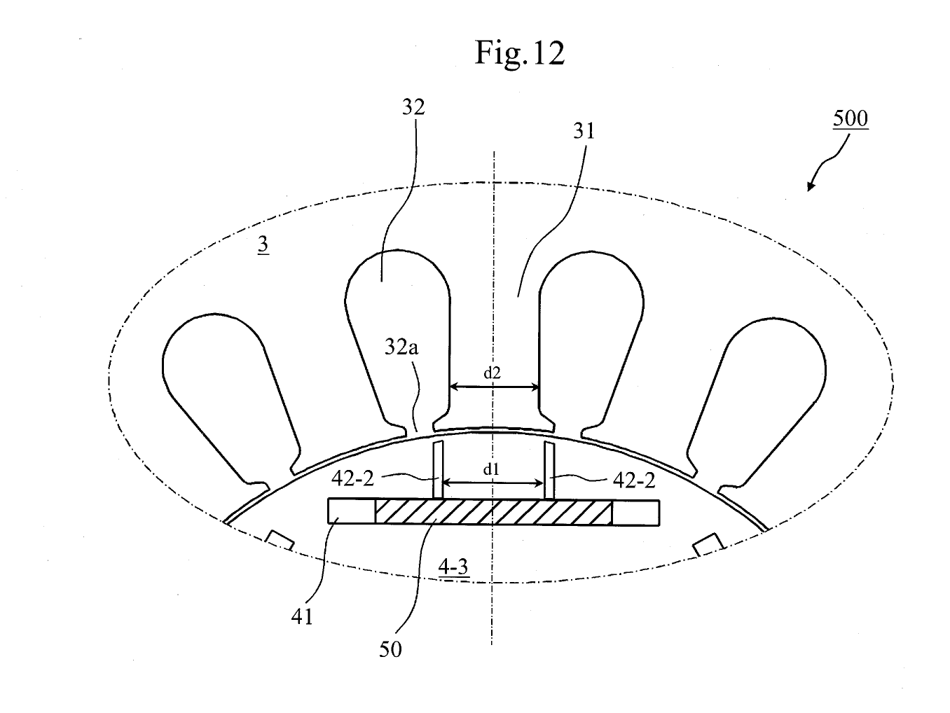

Here, configurations of motors 400 and 500 of the comparison examples, of which the torque and the cogging torque are compared with the motors 100 and 300, will be explained. FIGS. 11 and 12 are shown for comparison; FIG. 11 is a partial enlarged view of a motor 400 of a comparison example 1 (without slits), and FIG. 12 is a partial enlarged view of a motor 500 of a comparison example 2.

As shown in FIG. 11, no slit is formed on an outside core part of a magnet inserting hole 41 of a rotor 4-2 of the motor 400 of the comparison example 1. The other part of the configuration is the same as the motors 100 and 300.

As shown in FIG. 12, in the motor 500 of the comparison example 2, a pair of first slits 42-2 to be formed on an outside core part of a magnet inserting hole 41 of a rotor 4-3 is provided at an end part of a tip of the teeth 31 of the stator 3 (the rotor 4-3 side) in a peripheral direction. Therefore, the relation between the distance d1 which is between the pair of first slits 42-2 and the width d2 of the teeth 31 of the stator core 30 in a peripheral direction becomes d1≈d2 (d1 nearly equals d2).

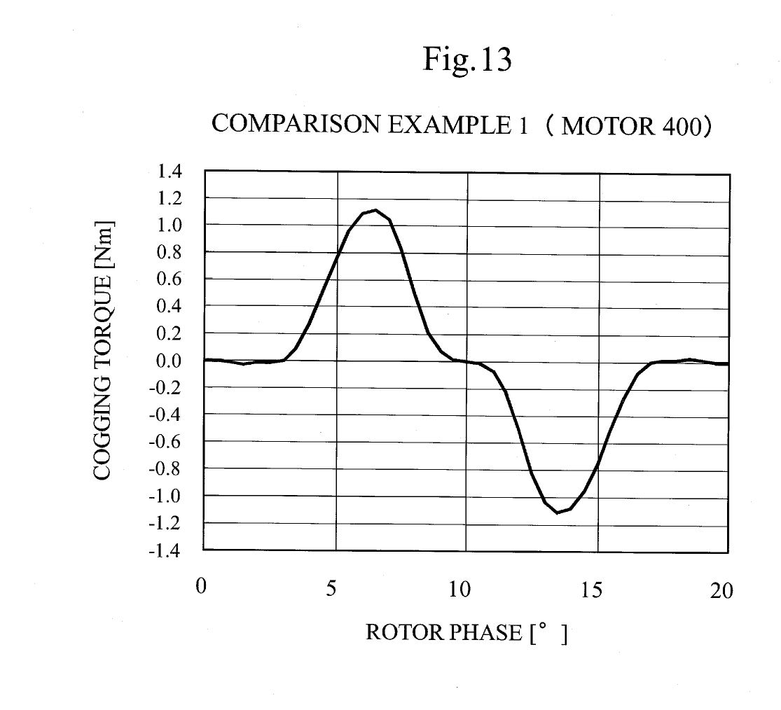

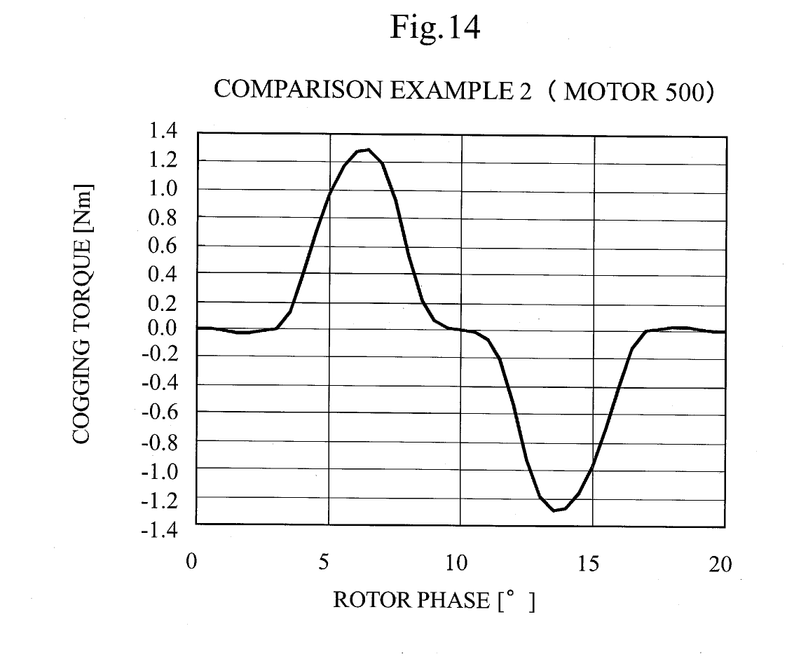

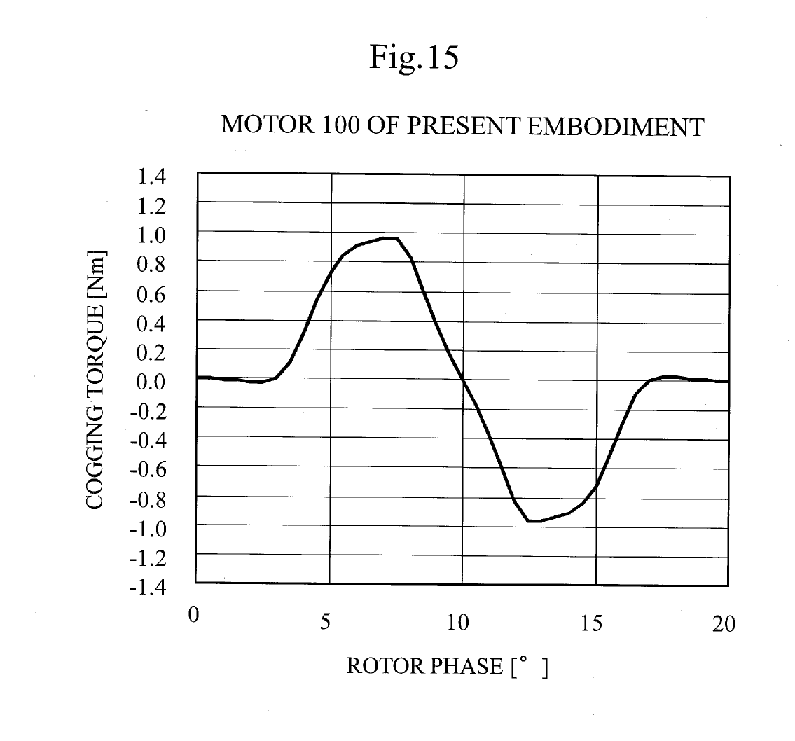

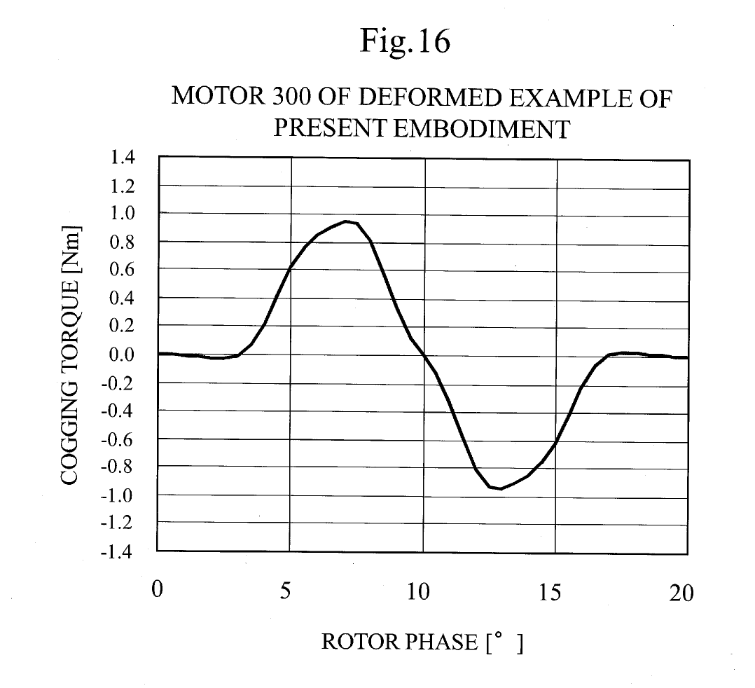

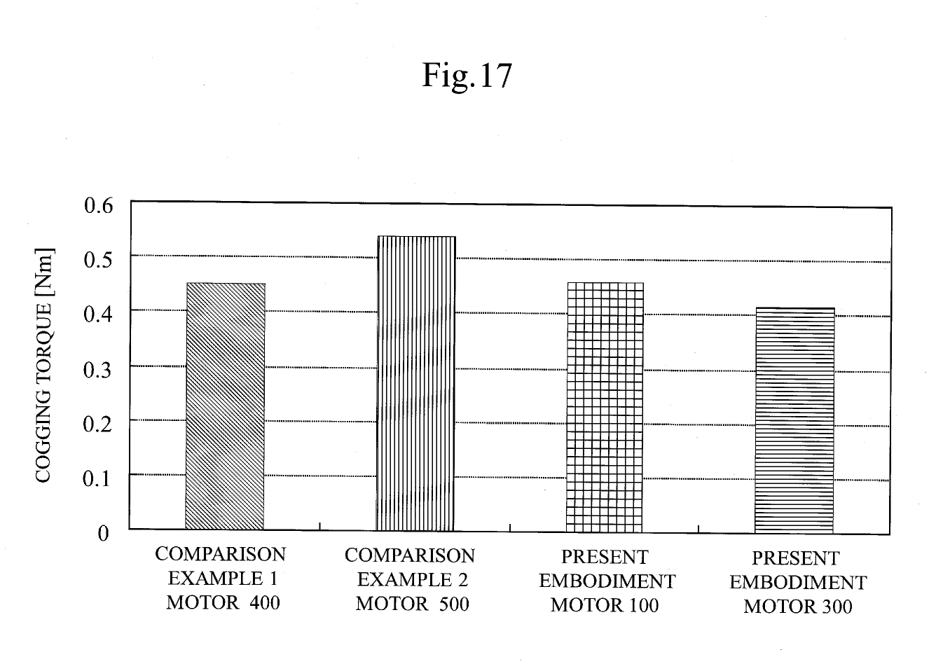

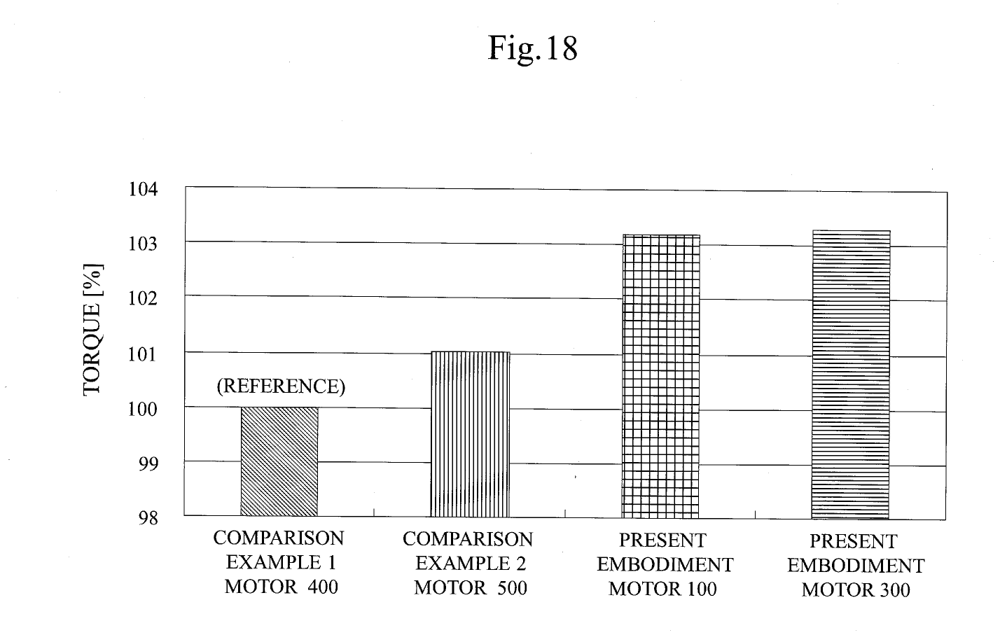

FIG. 13 shows a waveform of a cogging torque of the motor 400 of the comparison example 1, and FIG. 14 shows a waveform of a cogging torque of the motor 500 of the comparison example 2. FIGS. 15 to 18 show the first embodiment: FIG. 15 is a diagram showing a waveform of the cogging torque of the motor 100; FIG. 16 is a diagram showing a waveform of the cogging torque of the motor 300 of a deformed example; FIG. 17 compares cogging torques of the comparison example 1, the comparison example 2, the motor 100, and the motor 300; FIG. 18 compares torques of the comparison example 1, the comparison example 2, the motor 100, and the motor 300.

With reference to FIGS. 13 to 18, the advantageous effect of the motor 100 of the present embodiment and the motor 300 of the deformed example will be explained. As shown in FIGS. 13 to 16, in the motor 100 of the present embodiment and the motor 300 of the deformed example, it is understood that the waveform of the cogging torque is smoother, and also the peak value of the cogging torque is decreased when compared with the motor 400 of the comparison example 1 and the motor 500 of the comparison example 2.

As shown in FIGS. 17 and 18, the cogging torque and also the torque of the comparison example 2 (the motor 500) are higher when compared with the comparison example 1 (the motor 400) having no slits. The torque of the comparison example 2 (the motor 500) is high, because transverse flux is effectively decreased by the first slits 42-2, thereby solving magnetic flux saturation due to armature reaction and trace delay due to reluctance torque.

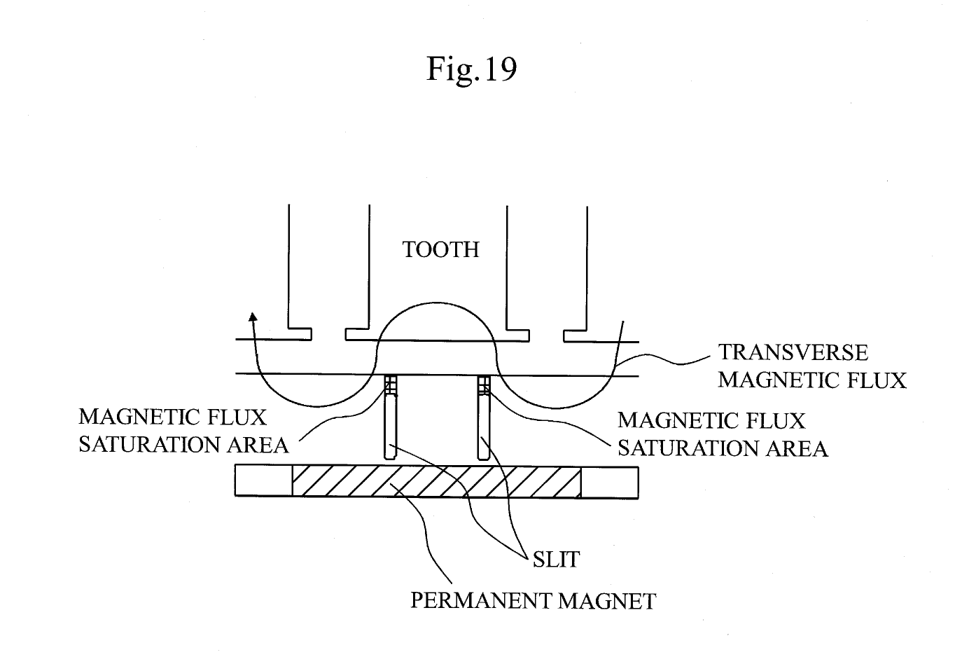

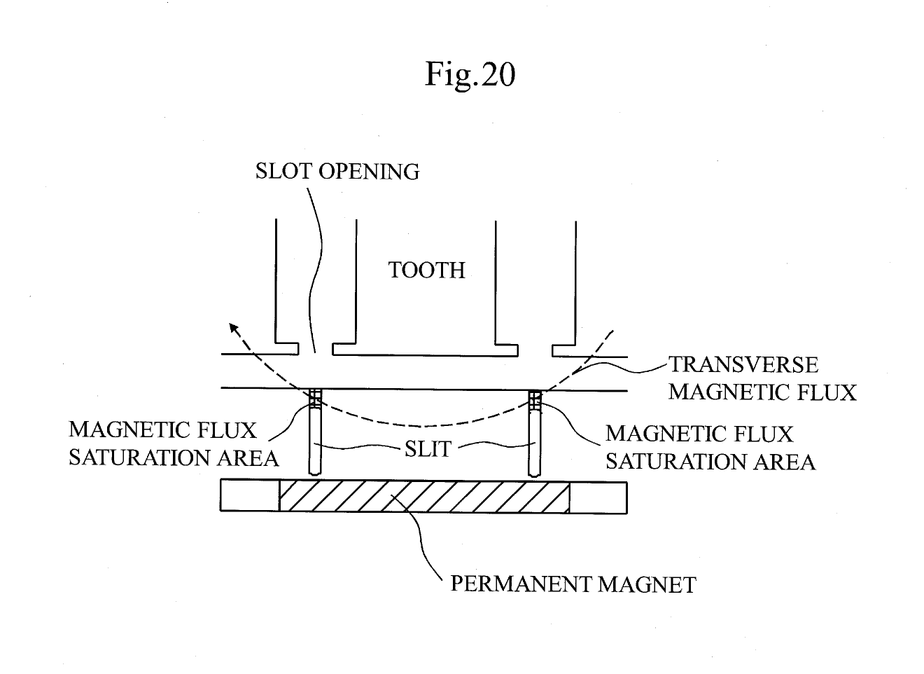

FIG. 19 is a reference drawing showing transverse flux; FIG. 20 is a reference drawing showing that slits are provided facing a slot openings or an end part of tooth of a stator, thereby suppressing the transverse flux. The transverse flux means, as shown in FIG. 19, the magnetic flux which straddles the teeth (of the stator) to the rotor core, to the teeth, to the rotor core, and to the tooth. As shown in FIG. 20, the slits are provided facing the slot openings or the end part of the tooth of the stator, thereby decreasing the transverse flux. In FIG. 20, the transverse flux is shown by a broken line to indicate the transverse flux is small.

On the other hand, the cogging torque of the comparison example 2 (the motor 500) is high, because the first slits 42-2 are provided at the position facing the end part of the tooth 31 in the peripheral direction, and thereby the distance dl between the pair of first slits 42-2 becomes approximately the same as the width d2 of the teeth. At the position shown in FIG. 12, since a magnetic pole center part between the pair of first slits 42-2 faces the tooth 31 with approximately the same width, the magnetic resistance between the stator 3 and the rotor 4-3 is minimized, and the status is the most stable magnetically. Further, it is also considered because the magnetic resistance between the stator 3 and the rotor 4-3 is maximized at the position where the magnetic pole center part between the pair of first slits 42-2 faces the slot opening 32a of the stator 3; and the magnetic attractive force trying to return to the position where the magnetic pole center part between the pair of first slits 42-2 faces the tooth 31 and where the magnetic resistance is minimized is larger than the case of the comparison example 1 (the motor 400) without slits.

The cogging torque of the motor 100 of the present embodiment is similar to the one of the motor 400 of the comparison example 1 and is smaller than the one of the motor 500 of the comparison example 2. Further, the torque of the motor 100 of the present embodiment is larger than the ones of the motor 400 of the comparison example 1 and the motor 500 of the comparison example 2.

The following two causes can be considered why the cogging torque of the motor 100 of the present embodiment is smaller than the one of the motor 500 of the comparison example 2:

(1) primarily, the pair of the second slits 43 are arranged at the position facing the slot openings 32a, thereby suppressing a precipitous change of the magnetic resistance between the stator 3 and the rotor 4; and
(2) secondarily, the pair of first slits 42 are added at the position closer to the magnetic pole center than the pair of the second slits 43, and the interval dl of the pair of first slits 42 is made equal to or less than the teeth width d2, thereby smoothing further an air gap flux distribution.

Here, the pair of first slits 42 are added at the position closer to the magnetic pole center than the pair of the second slits 43, since smoothing of the magnetic flux distribution is more effective around the magnetic pole center.

Further, the torque of the motor 100 of the present embodiment is increased more than the motor 400 of the comparison example 1 and the motor 500 of the comparison example 2, since the effect of suppressing the transverse flux is improved by adding the pair of first slits 42 or the pair of the second slits 43.

In the following, the advantageous effect of the motor 300 of the deformed example of the present embodiment will be explained by comparing with the motor 100 of the present embodiment. The cogging torque of the motor 300 of the deformed example is smaller than the one of the motor 100 (refer to FIG. 17). Further, the torque of the motor 300 of the deformed example is approximately the same as the one of the motor 100.

The cogging torque of the motor 300 of the deformed example is decreased than the one of the motor 100, because the width d3 of the outer peripheral thin part of the first slit 42-1 provided at the rotor 4-1 is made:

d5/2>d3>the thickness of each electromagnetic plate and further,

d3>d4.

It is advantageous effect of the above configuration which moderates influence of the magnetic flux saturation of the outer peripheral thin part of the first slit 42-1 and reduces ripple degrading the peak level of the cogging torque. Here, it is to prevent the punching property of the electromagnetic plate from degrading the reason why the width d3 of the outer peripheral thin part of the first slit 42-1 is made equal to or greater than the thickness of each electromagnetic plate (the electromagnetic plate may be distorted, if d3 is made equal to or less than the thickness of each electromagnetic plate).

The peak of the cogging torque at a specific degree is influenced by the number of slots of the stator, the number of magnetic poles, and the number of slits provided at the outer peripheral part of the permanent magnet inserting hole of the rotor. However, in any case, if the thickness of the outer peripheral thin part of the slit provided at the rotor is made non-uniform, the peak of the cogging torque at a specific degree can be reduced.

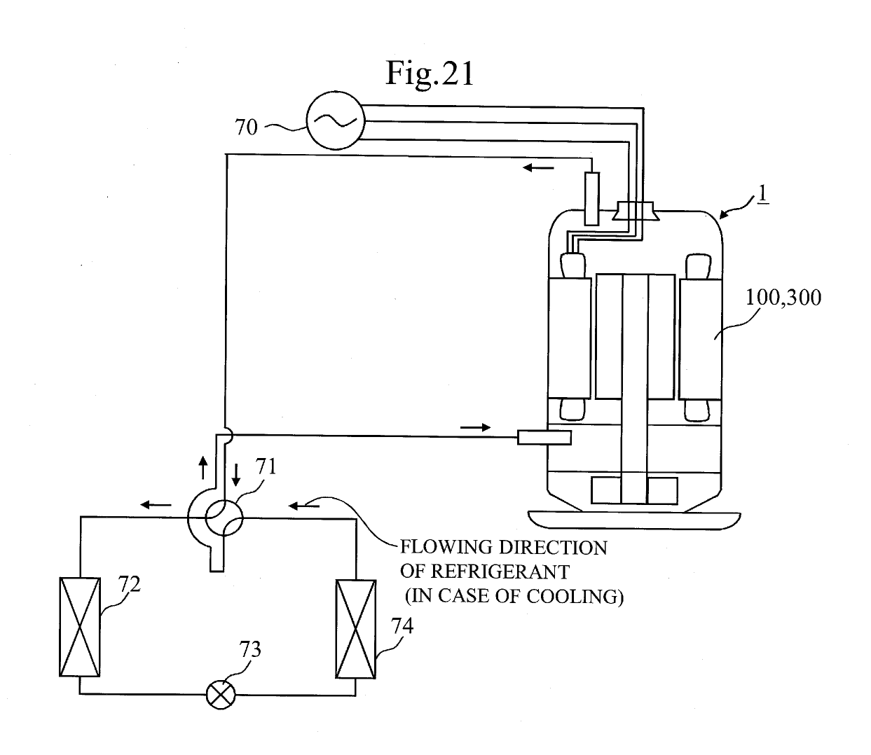

FIG. 21 shows the first embodiment, which is a configuration diagram of the refrigeration cycle apparatus using the two-cylinder rotary compressor 1. The refrigeration cycle apparatus is, for instance, an air conditioner. The two-cylinder rotary compressor 1 is connected to the commercial power source 70. The power is supplied from commercial power source 70 to the two-cylinder rotary compressor 1, thereby driving the two-cylinder rotary compressor 1. The refrigeration cycle apparatus (e.g., an air conditioner) includes the two-cylinder rotary compressor 1, a four-way valve 71 switching flowing direction of refrigerant, an outdoor heat exchanger 72, a decompressor 73, an indoor heat exchanger 74, and so on. These are connected with refrigerant piping.

In the case of cooling operation of the refrigeration cycle apparatus (e.g., the air conditioner), refrigerant flows like arrows shown in FIG. 21. The outdoor heat exchanger 72 becomes a condenser. Further, the indoor heat exchanger 74 becomes an evaporator.

Although it is not shown in the figure, in the case of heating operation of the refrigeration cycle apparatus (e.g., the air conditioner), the refrigerant flows in the opposite direction to the arrows of FIG. 21. The flowing direction of the refrigerant is switched by the four-way valve 71. At this time, the outdoor heat exchanger 72 becomes the evaporator. Further, the indoor heat exchanger 74 becomes the condenser.

Further, as for the refrigerant, HFC system refrigerant represented by R134a, R410a, R407c, etc., or natural refrigerant represented by R744 (CO₂), R717 (ammonia), R600a (isobutane), or R290 (propane), etc. is used. As for the refrigerant oil, less compatible oil represented by alkyl benzene system oil, or compatible oil represented by ester oil is used. As for the compressor, other than the rotary type, a reciprocating type compressor, a scroll type compressor, etc. can be used.

The two-cylinder rotary compressor 1, on which the motor 100 or 300 having excellent property of the cogging torque or the torque is mounted, is used for the refrigeration cycle, thereby improving the performance of, downsizing, and lowering the cost of the refrigeration cycle apparatus.

Numerous additional modifications and variations are possible in light of the above teachings. It is therefore to be understood that, within the scope of the appended claims, the disclosure of this patent specification may be practiced otherwise than as specifically described herein.

### Explanation of Signs

1: a two-cylinder rotary compressor; 2: a hermetic container; 3: a stator; 4: a rotor; 4-1: a rotor; 4-2: a rotor; 4-3: a rotor; 5a: a first cylinder; 5b: a second cylinder; 6: a main bearing; 7: an auxiliary bearing; 8: a rotating shaft; 8a: a main shaft; 8b: an auxiliary shaft; 8c: a main shaft side eccentric part; 8d: an auxiliary shaft side eccentric part; 8e: an intermediate shaft; 9a: a first piston; 9b: a second piston; 10a: a discharge muffler; 10b: a discharge muffler; 11: an accumulator; 12a: a suction tube; 12b: a suction tube; 13: a discharge tube; 14: an air gap; 24: a glass terminal; 25: a lead wire; 26: lubricant oil; 27: a partitioning plate; 30: a stator core; 31: a tooth; 32: a slot; 32a: a slot opening; 33: a coreback; 40: a rotor core; 40-1: a rotor core; 41: a magnet inserting hole; 42: a first slit; 42-1: a first slit; 42-2: a first slit; 43.: a second slit; 43-1: a second slit; 44: a shaft hole; 50: a permanent magnet; 70: commercial power source; 71: a four-way valve; 72: an outdoor heat exchanger; 73: a decompressor; 74: an indoor heat exchanger; 100: a motor; 200: a compressor mechanism part; 300: a motor; 400: a motor; and 500: a motor.

1. A motor for a compressor comprising:
a stator formed by laminating a predetermined number of electromagnetic plates, each of which has been punched out into a predetermined shape, the stator having a plurality of slots arranged in a peripheral direction with an approximate equal intervals and each having a slot opening that opens at an inner periphery, teeth formed between neighboring slots, and coils wound around the teeth; and
a rotor arranged at an inner side of the stator with an air gap, and formed by laminating a predetermined number of electromagnetic plates, each of which has been punched out into a predetermined shape, the rotor having permanent magnet inserting holes formed along an outer peripheral edge, as many as a number of magnetic poles, and permanent magnets to be inserted into the permanent magnet inserting holes,
wherein the rotor includes at least
a first pair of slits provided at an outer peripheral core part of each of the permanent magnet inserting holes, extending orthogonally to the each of the permanent magnet inserting holes, and arranged symmetrically with respect to a magnetic pole center, a distance between the first pair of slits being smaller than a width of each of the teeth; and
a second pair of slits provided at the outer peripheral core part of the each of the permanent magnet inserting holes, each of the second pair of slits being arranged at an outside of each of the first pair of slits where it is farther from the magnetic pole center than the each of the first pair of slits, and facing the slot opening when one of the teeth and the magnetic pole center are aligned.

2. The motor for compressor of claim 1, wherein the motor satisfies relation of:
d3>d4;
d5/2>d3>a thickness of each electromagnetic plate; and
d5/2>d4>a thickness of each electromagnetic plate,
where d3 is a width of an outer peripheral thin part of the first pair of slits, d4 is a width of an outer peripheral thin part of the second pair of slits, and d5 is a distance between the each of the permanent magnet inserting holes and an outer periphery of the rotor on the magnetic pole center.

3. A compressor comprising the motor of claim 1.

4. A refrigeration cycle apparatus comprising:
the compressor of claim 3;
a four-way valve switching a flowing direction of refrigerant;
an outdoor heat exchanger;
a decompressor; and
an indoor heat exchanger.
